(19) United States
(12) Patent Application Publication
(10) Pub. No.: US 2013/0209186 A1
(43) Pub. Date: Aug. 15, 2013

(54) MACHINING METHOD AND APPARATUS HAVING CRYOGENIC COOLING

(71) Applicants: Jacques Quintard, Houston, TX (US); Frédéric Richard, Houston, TX (US); Frédéric Rotman, Houston, TX (US); Charles Truchot, Houston, TX (US)

(72) Inventors: Jacques Quintard, Houston, TX (US); Frédéric Richard, Houston, TX (US); Frédéric Rotman, Houston, TX (US); Charles Truchot, Houston, TX (US)

(73) Assignee: L'Air Liquide Societe Anonyme Pour Ietude et I'Exploitation de Procedes Georges Claude, Paris (FR)

(21) Appl. No.: 13/880,775

(22) PCT Filed: Oct. 6, 2011
(86) PCT No.: PCT/FR2011/052331

§ 371 Date: Apr. 22, 2013

(30) Foreign Application Priority Data
Oct. 22, 2010 (FR) 1058638

(51) Int. Cl. B23B 47/00

(52) U.S. Cl. CPC B23B 47/00
USPC 408/1 R; 408/56

(57) ABSTRACT

The invention relates to a method for machining a part to be machined using a machining tool, in which at least a portion of the machining area, likely to be heated during the machining of the part, or a portion of the machining tool is cooled by dispensing liquid nitrogen to said machining area or said tool. Solid CO₂ particles are also dispensed into the machining area. The invention also relates to an apparatus for implementing said method.

The invention relates to a process for machining a part to be machined with a machining tool, in particular a drilling or cutting tool, in which the machining region is efficiently cooled by means of a cryogenic mixture formed of liquid nitrogen and of particles of solid CO₂, and to an apparatus for the implementation of this process.

During a machining operation on a metal part, for example a mechanical cutting or drilling operation, the friction, the rubbing actions and the generation of heat of the machining region or heating region are frequent problems which often require introduction of efficient lubrication and/or cooling of the machined metal material.

In order to do this, a cooling and/or lubricating compound, typically water or oil, for example, is applied on contact with the machined region or heating region, which makes it possible not only to more or less efficiently cool this region but also to lubricate it so as to improve the lifetime of the machining tool, to improve the dimensional accuracy and/or to reduce the surface roughness of the machined article.

The term “cooling and/or lubricating compound” is understood to mean any substance which makes it possible to cool and optionally lubricate the parts or components in contact, that is to say material and tool, and thus to reduce the temperature of the parts or components under consideration, for example water or steam, oils, a gas, and the like.

The decrease in temperature brought about by contact with the cooling compound also makes it possible to improve the machining parameters and thus to increase the overall productive output of the machining operation.

However, it turns out that conventional cooling and/or lubricating compounds are not effective enough to be able to effectively cool certain hard materials, such as, for example, stainless steel, at high machining rates during their machining as the heat produced by the rubbing actions of the tool over these hard materials is too great to be effectively absorbed by these conventional compounds.

This then results in a greatly reduced lifetime of the tool, indeed even machining defects, caused by an excessive increase in the temperature of the material.

Furthermore, for some applications, such as the machining of parts used in the medical field, any chemical lubricant is to be banned because of problems of surface contamination.

Finally, for environmental reasons, chemical lubricants are less and less used.

One alternative to the use of chemical lubricants is dry machining. However, the poor removal of the heat generated prevents high throughput dry machining.

Furthermore, provision has been made, by the document EP-A-35145, to use a mixture formed of liquid CO₂ and of a chemical lubricant during machining. However, such a mixture is not very practical to employ.

Similarly, the document U.S. Pat. No. 3,971,114 provided for the use of freon 12 as cooling gas. This solution is not ideal as, here again, the cooling ability of the freon is limited and, moreover, freon is capable of presenting environmental problems.

For its part, the document EP-A-1 580 284 provides for the use of liquid argon or liquid helium, alternatively to liquid CO₂, as lubricating and cooling fluid during a machining. In point of fact, it is immediately understood that such a solution is not viable or else very limited industrially as a result of the significant cost constraints which it generates, and also the difficulties in implementation which it may bring about, in particular in the event of use of liquid helium.

In addition, the proposal has also been made, by EP-A-1 580 284 and also by the documents WO-A-9960079, EP-A-2 155 451 and EP-A-1 775 064, to use liquid nitrogen at atmospheric pressure as lubricating and cooling fluid during a machining.

This is because, at atmospheric pressure, liquid nitrogen is at approximately −196° C. and its refrigerating contribution is noteworthy, which makes it a markedly better solution than the other gases provided.

By way of example, the lifetime of a cutting tool coated with tungsten carbide used to cut stainless steel at a rate of 100 m/min will be from 3 to 4 times greater if liquid nitrogen at atmospheric pressure is used in place of a standard lubricant, such as water or oil.

However, liquid nitrogen is known to create a heating layer when it comes into contact with a part which is warmer than it, that is to say at a temperature greater than −196° C. The warmer the part, the more significant the heating layer.

This point is particularly notable during a mechanical machining operation as the difference in temperature between the liquid nitrogen and the part to be machined can range, for example, from 500 to 1000° C.

This heating layer is composed of gaseous nitrogen which forms between the liquid nitrogen and the part to be machined, a gaseous thermal barrier which limits the refrigerating contribution originating from the liquid nitrogen.

In point of fact, this poorer refrigerating contribution limits the removal of the heat produced by the machining and de facto limits the overall productive output as the cooling and/or the lubrication will consequently be less effective.

It is thus understood that the use of liquid nitrogen is not ideal as the result of the existence of this heating layer.

Furthermore, the documents EP-A-1 044 762 and WO-A-2006/065869 disclose solid CO₂ mixed with nitrogen in the gaseous form.

In addition, EP-A-1 580 284 relates to a process for improving the working surface of a tool during the shaping thereof by injection of liquid nitrogen at the surface of the tool.

From there, the problem is to be able to improve the cooling by liquid nitrogen during a machining operation of a material, in particular the drilling or the cutting of a hard material, such as carbon steel, stainless steel, aluminum and its alloys, or an alloy based on chromium and/or on nickel, or on titanium, and the like.

The solution provided is a process for machining a part to be machined with a machining tool, in which at least a portion of the machining region capable of becoming overheated during the machining of the part or of the machining tool is cooled by dispensing liquid nitrogen at said machining region or at the tool, characterized in that, in addition, particles of CO₂ in the solid form are dispensed in the machining region.

In other words, according to the invention, provision is made to carry out cooling of the machining region and/or of the machining tool, that is to say of the components which become overheated during the machining proper, by virtue of bringing the machining region and optionally the tool itself into contact with solid particles mixed with a cryogenic fluid in the liquid state, that is to say liquid nitrogen, which is typically at a temperature of the order of −196° C., so as to break down all or part of the heating layer capable of being formed by evaporation of the liquid nitrogen to give gaseous nitrogen on contact with the hot components and thus to significantly improve the cooling and/or the lubrication of the machining region in comparison with use of liquid nitrogen alone.

It should be noted that, in the context of the invention:
the term “to dispense” is regarded as completely equivalent to the terms “to inject”, “to send” or “to deliver”.
the terms “machining region” and “overheating region” are used without distinction with regard to one another to denote the area of the part to be machined which is capable of being overheated as a result of the machining proper.
the liquid nitrogen is nitrogen (chemical designation: N₂) in the liquefied state, that is to say at a temperature typically of the order of from −190° C. to −200° C., in particular at −196° C. at atmospheric pressure (1 atm). The purity of the liquid nitrogen is typically at least 99% by volume, that is to say that it is not ruled out for the nitrogen to be able to comprise inevitable impurities.
the particles of CO₂ in the solid form are crystals of carbon dioxide, commonly known as “ dry ice”.

As the case may be, the process of the invention can comprise one or more of the following characteristics:
the particles of CO₂ in the solid form are mixed with the liquid nitrogen,
particles of CO₂ in the solid form are dispensed,
a cooling jet formed of liquid nitrogen and of 10 to 70% by weight of particles of CO₂ in the solid form is dispensed,
the cooling jet formed of liquid nitrogen and of solid particles is at a pressure of between 1 and 400 bar,
the mixing of liquid nitrogen and of solid particles is carried out in situ, simultaneously with or immediately before the dispensing thereof,
the liquid nitrogen and the solid particles are dispensed via one or more dispensing nozzles,
the machining is a drilling or a cutting,
the part to be machined is formed of a metal, ceramic, composite or plastic material,
the part to be machined is formed of a metal material chosen from carbon steel, aluminum and its alloys, stainless steel, alloys of nickel and/or of chromium, and titanium and titanium alloys.

Furthermore, the invention also relates to a machining apparatus comprising a machining tool and at least one dispensing nozzle in contact in fluid terms with a source of cooling fluid, characterized in that the source of cooling fluid is capable of feeding and designed to feed the nozzle with a mixture formed of liquid nitrogen and of particles of solid CO₂.

The present invention will be described in more detail with reference to the appended figures, among which:

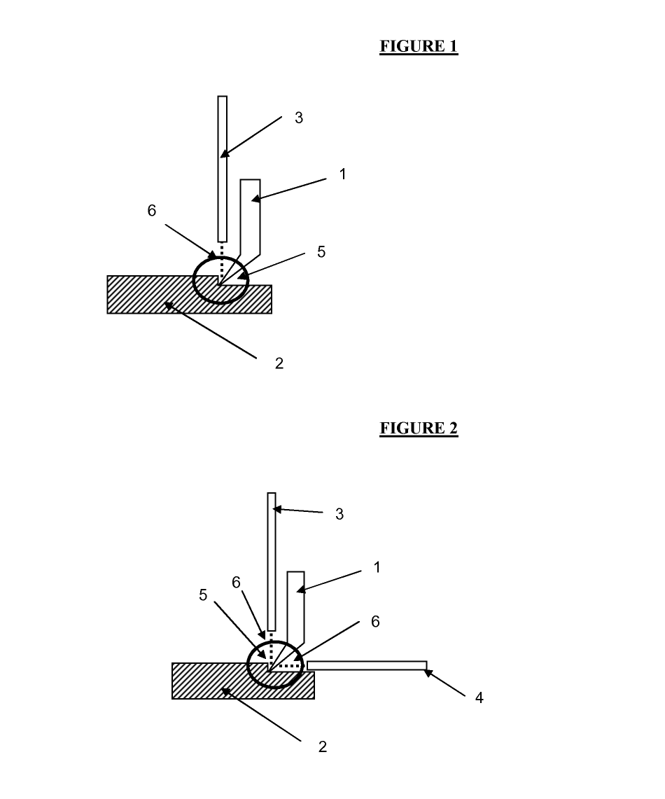

FIG. 1 represents a first embodiment of the invention and

FIG. 2 represents a second embodiment of the invention.

FIG. 1 illustrates a first embodiment of the machining process of the invention.

As is seen, a part 2 to be machined, for example a metal part or plastic part, is subjected to a machining operation, such as a drilling, a cutting or other operation, by means of a machining tool 1, for example a rotating or oscillating tool, such as a milling cutter.

Throughout the duration of the machining, the region or area 5 of the part 2 machined by the tool 1 undergoes overheating as a result of the rubbing actions or the like which take place between the tool 1 and the part 2.

In order to alleviate this overheating, all or part of the machining region 5 capable of being overheated is cooled by dispensing liquid nitrogen at said machining region 5 and optionally also at the tool 1.

In this first embodiment, a single jet 6, formed of liquid nitrogen mixed with particles of CO₂ in the solid form, typically a mixture of liquid nitrogen comprising from 10% to 70% by weight of particles of CO₂ in the solid form, that is to say in the form of dry ice, is sent to the machining region 5.

This liquid nitrogen/solid CO₂ mixture is produced in situ, either in the dispensing nozzle 3 which delivers the single jet 6, or upstream of said nozzle 3, for example in a mixing chamber connected, on the one hand, to a source of solid CO₂ and, on the other hand, to a source of liquid nitrogen.

FIG. 2 illustrates a second embodiment of the invention analogous to that of FIG. 1 but in which the injection of liquid nitrogen and of the particles of solid CO₂ takes place using two injection nozzles 3 and 4, for example in this instance a first nozzle 3 arranged vertically and a second nozzle 4 arranged horizontally.

In this second embodiment, the two nozzles 3 and 4 can each dispense a liquid nitrogen/solid CO₂ mixture.

Alternatively, one of the nozzles 3 and 4 can dispense liquid nitrogen and the other can dispense the particles of solid CO₂, the mixing thereof taking place in situ in the machining region 5 to be cooled.

It is also possible to imagine dispensing a liquid nitrogen/solid CO₂ mixture by means of one of the two nozzles 3 and 4 and to use the other nozzle to dispense solely liquid nitrogen or CO₂ in solid form.

Generally, the particles of CO₂ used are solid at cryogenic temperature, that is to say typically at less than −150° C., but become gaseous as soon as their temperature exceeds approximately −78 ° C., thus a fortiori at ambient temperature.

Specifically, CO₂ has a thermal conductivity at −196° C., which is the temperature of liquid nitrogen, of the order of 0.05 W/(m.K), thus markedly greater than that of gaseous nitrogen at the same temperature, namely 0.0145 W/(m.K).

In the context of the invention (FIGS. 1 and 2), the solid CO₂, in addition to its role of disintegrating the heating layer which is formed at the interface between the liquid nitrogen and the surface of the part 2, also has a thermal bridge effect and withdraws heat, making it possible to also cool the machining region.

In addition, the CO₂ will not create secondary waste which has to be retreated, nor damage or interfere with the machining process proper, as a result of its low abrasive effect.

Preferably, a premix of CO₂ in the form of dry ice and of liquid nitrogen is manufactured before injection into the machining region 5. Under these conditions, the particles of solid CO₂ are cooled to approximately −196° C., that is to say the temperature of the liquid nitrogen in which they are found.

Experimental trials have shown that cooling by immersion of a bulk part made of steel heated to a temperature of 20° C. in liquid nitrogen down to a given temperature of the order of −190° C. requires a cooling time which is 50% greater than that necessary in order to obtain the same cooling using a mixture formed of liquid nitrogen and of 30% by weight of CO₂.

Consequently, the advantage of using a dry ice/liquid nitrogen mixture as cooling/lubricating fluid for machining is immediately understood.

Specifically, during these trials, it was demonstrated that the particles of solid CO₂ will drastically limit the effect of the heating layer created by the liquid nitrogen in contact with the part to be cooled, which improves the transfers of heat.

The liquid nitrogen/solid CO₂ mixture according to the invention has to comprise more than 10% by weight of CO₂ in order to obtain a significant effect of the CO₂ and at most 70% by weight of CO₂ in order to retain a viscosity of the mixture compatible with injection processes.

The stream of liquid nitrogen/solid CO₂ cryogenic mixture can be injected vertically, as illustrated in FIG. 1, but also horizontally or along a given angle between the horizontal position and the vertical position. The angle of injection most suitable for the given machining can be easily determined empirically, on an individual basis, as a function in particular of the configuration of the part and/or of the tool, of the effectiveness of the cooling to be obtained, and the like.

The part 2 to be machined and to be cooled can be formed of a ferrous or nonferrous metal material, such as stainless steel, titanium or one of its alloys, or an alloy based on chromium or nickel, such as an Inconel, or of a nonmetal material, in particular plastic polymer material, such as a plastic of the type having high ductile performances (PPS, PI, PAI, and the like), or of a ceramic.

Preferentially, the machining region 5 is cooled but it is also possible to simultaneously cool all or part of the tool 1 itself by means of the liquid nitrogen/solid CO₂ mixture.

1-11. (canceled)

12. A process for machining a part with a machining tool, in which at least a portion of a machining region capable of becoming overheated during the machining of the part or of the machining tool is cooled by dispensing liquid nitrogen at said machining region and/or at the machining tool, wherein additionally particles of CO₂ in solid form are dispensed at least in the machining region.

13. The process of claim 12, wherein the particles of CO₂ in are mixed with the liquid nitrogen.

14. The process of claim 12, wherein particles of CO₂ are dispensed.

15. The process of claim 12, wherein a cooling jet formed of liquid nitrogen and of 10 to 70% by weight of particles of CO₂ is dispensed.

16. The process as of claim 12, wherein the cooling jet formed of liquid nitrogen and of CO₂ is at a pressure of between 1 and 400 bar.

17. The process of claim 12, wherein the mixing of liquid nitrogen and of CO₂ is carried out in situ, simultaneously with or immediately before the dispensing thereof.

18. The process of claim 12, wherein the liquid nitrogen and the CO₂ are dispensed via one or more dispensing nozzles.

19. The process of claim 12, wherein the machining is a drilling, a cutting, a milling or a turning.

20. The process of claim 12, wherein the part to be machined is formed of a metal, plastic, composite or ceramic material.

21. The process of claim 12, wherein the part to be machined is formed of a metal material chosen from carbon steel, aluminum and its alloys, stainless steel, alloys of nickel and/or of chromium, and titanium and titanium alloys.

22. A machining apparatus comprising a machining tool and at least one dispensing nozzle in contact in fluid terms with a source of cooling fluid, wherein the source of cooling fluid is capable of feeding and designed to feed the nozzle with a mixture formed of liquid nitrogen and of particles of solid CO₂.
